(19) United States
(12) Patent Application Publication
(10) Pub. No.: US 2020/0089443 A1
(43) Pub. Date: Mar. 19, 2020

(54) PRINTING SYSTEM, INFORMATION PROCESSING APPARATUS, METHOD OF CONTROLLING SAME, STORAGE MEDIUM, EXTERNAL APPARATUS, METHOD OF CONTROLLING SAME, AND STORAGE MEDIUM

(71) Applicant: CANON KABUSHIKI KAISHA, Tokyo (JP)

(72) Inventors: Masaki Kashiwagi, Hiratsuka-shi (JP); Takeshi Kaneda, Funabashi-shi (JP); Akinori Takeo, Yokohama-shi (JP); Jun Miyajima, Toride-shi (JP); Seijiro Imai, Toride-shi (JP)

(21) Appl. No.: 16/561,605

(22) Filed: Sep. 5, 2019

(30) Foreign Application Priority Data
Sep. 13, 2018 (JP) 2018-171937

(51) Int. Cl. G06F 3/12

(52) U.S. Cl. CPC G06F 3/1226; G06F 3/126; G06F 3/1205

(57) ABSTRACT

An information processing apparatus receives capability information from each of a plurality of image forming apparatuses, and calculates a product set of pieces of capability information indicating capabilities (such as two-sided/one-sided printing and supported sheet sizes) of the plurality of image forming apparatuses. An external apparatus displays the product set of pieces of capability information when a user makes print settings.

### BACKGROUND

### Field of the Disclosure

The present disclosure relates to a printing system, an information processing apparatus, a method of controlling the same, a storage medium, an external apparatus, a method of controlling the same, and a storage medium.

### Description of the Related Art

A printing system in which a plurality of image forming apparatuses, such as a multifunction peripheral, is connected to a terminal device, such as a personal computer (PC), and the plurality of image forming apparatuses performs print processing on a print job generated by the terminal device in a distributed manner has heretofore been known.

For such a printing system, a technique by which the terminal device calculates a product set of pieces of capability information indicating capabilities (such as two-sided/one-sided printing and supported sheet sizes) of the plurality of image forming apparatuses and displays capabilities related to a user's print setting in terms of a product set has been discussed (Japanese Patent Application Laid-Open No. 2001-290625).

In the printing system discussed in Japanese Patent Application Laid-Open No. 2001-290625, to calculate the product set of pieces of capability information about the plurality of image forming apparatuses, the terminal device needs to request each of the image forming apparatuses capability information. There is thus an issue of heavy load on the terminal device.

### SUMMARY

The present disclosure is directed to reducing the load of a terminal device when the terminal device requests capability information about a plurality of image forming apparatuses to calculate a product set of pieces of capability information about the plurality of image forming apparatuses.

The present disclosure is also directed to reducing the load of the terminal device when the terminal device requests capability information about the plurality of image forming apparatuses.

According to an aspect of the present disclosure, a printing system includes a plurality of predetermined image forming apparatuses, an information processing apparatus, and an external apparatus, wherein the information processing apparatus includes a first reception unit configured to receive capability information transmitted from each of the plurality of predetermined image forming apparatuses, the capability information indicating capabilities that a respective one of the plurality of predetermined image forming apparatuses has, and a storage unit configured to store the capability information received by the first reception unit, wherein the external apparatus includes a display unit configured to display a print setting for accepting a setting based on the capability information, and a request unit configured to request the information processing apparatus capability information indicating a capability that all the plurality of predetermined image forming apparatuses has, wherein the information processing apparatus further includes a first transmission unit configured to transmit the capability information based on a request from the request unit, and wherein the display unit is configured to display the capability information indicating the capability that all the plurality of predetermined image forming apparatuses has.

According to another aspect of the present disclosure, an external apparatus configured to be connected to an information processing apparatus configured to receive capability information indicating capabilities of each of a plurality of predetermined imaging apparatuses includes a display unit configured to display the capability information as a print setting, and a request unit configured to request the information processing apparatus capability information indicating a capability that all the plurality of predetermined image forming apparatuses has, wherein the display unit is configured to display the capability information indicating the capability that all the plurality of predetermined image forming apparatuses has.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a printing system.

FIG. 2 is a diagram illustrating an example of a hardware configuration of a multifunction peripheral (MFP).

FIG. 3 is a diagram illustrating an example of a hardware configuration of a virtual printer (cloud server).

FIG. 4 is a diagram illustrating an example of a hardware configuration of a terminal device.

FIG. 5 is a diagram illustrating an example of a software configuration of the MFP.

FIG. 6 is a diagram illustrating an example of a software configuration of the virtual printer.

FIG. 7 is a diagram illustrating an example of a software configuration of the terminal device.

FIG. 8 is a sequence diagram illustrating an example of a sequence in registering capability information about an MFP in the virtual printer.

FIG. 9 is a sequence diagram illustrating an example of a sequence when an MFP receiving a print job from a terminal device via the virtual printer executes the print job.

FIG. 10 is a diagram illustrating examples of capability information about MFPs.

FIG. 11 is a flowchart illustrating an example of processing performed by the virtual printer.

FIG. 12 is a flowchart illustrating an example of processing performed by a terminal device.

FIG. 13 is a diagram illustrating examples of messages in transmitting a device registration request and a registration result notification by Internet Printing Protocol (IPP) communication between an MFP and the virtual printer.

FIG. 14 is a diagram illustrating examples of messages about a capability information request that the virtual printer transmits to an MFP by IPP communication and capability information that the MFP transmits to the virtual printer by IPP communication.

FIG. 15 is a diagram illustrating examples of messages about a capability information request that a terminal device transmits to the virtual printer by IPP communication and capability information that the virtual printer transmits to the terminal device by IPP communication.

FIG. 16 is a diagram illustrating examples of messages about a capability information request that a terminal device transmits to the virtual printer by IPP communication and capability information that the virtual printer transmits to the terminal device by IPP communication.

FIG. 17 is a diagram illustrating examples of a print setting screen displayed on a terminal device.

FIG. 18 is a sequence diagram illustrating an example of a sequence when an MFP receiving a print job from a terminal device via the virtual printer executes the print job.

FIG. 19 is a diagram illustrating examples of a message including a request for capability information about MFPs that a terminal devices transmits to the virtual printer by IPP communication and a message that the virtual printer transmits to the terminal device by IPP communication, indicating that no capability information is generated.

### DESCRIPTION OF THE EMBODIMENTS

Exemplary embodiments for carrying out the present disclosure will be described below with reference to the drawings. The configurations described in the following exemplary embodiments are merely examples, and the present disclosure is not limited to the illustrated configurations.

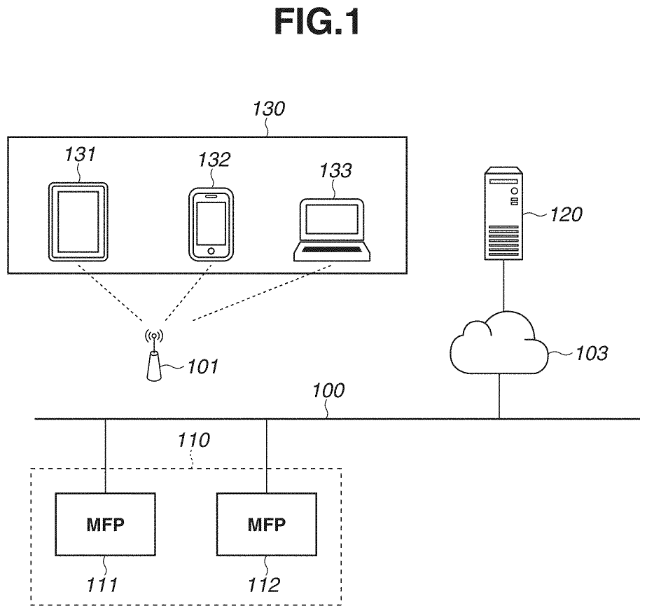

A first exemplary embodiment will be described below. FIG. 1 is a diagram illustrating an example of a configuration of a printing system. The printing system illustrated in FIG. 1 includes multifunction peripherals (MFPs) 111 and 112 that are image forming apparatuses, terminal devices 131, 132, and 133 that are external apparatuses, and a cloud server that is an information processing apparatus and operates as a virtual printer. The MFPs 111 and 112 are collectively referred to as an MFP 110. Examples of the terminal devices 131, 132, and 133 include external apparatuses such as a tablet, a smartphone, and a personal computer (PC). The terminal devices 131, 132, and 133 are collectively referred to as a terminal device 130.

The MFP 110 and the terminal device 130 are connected to each other via an access point 101 connected to a local area network (LAN) 100. In the present exemplary embodiment, the terminal device 130 is connected to the LAN 100 by using wireless communication. However, this is not restrictive. For example, the terminal device 130 may be connected by using wired communication.

The LAN 100 to which the MFP 110 and the terminal device 130 are connected is connected to the Internet 103. The MFP 110 and the terminal device 130 can be connected to a cloud server 120 via the Internet 103.

The MFPs 111 and 112 may have the same or different print processing capabilities.

In the present exemplary embodiment, the printing system is described by using the foregoing configuration as an example. However, the present disclosure is not limited thereto. The printing system may include at least one terminal device and at least one MFP connected to the cloud server 120 via the LAN 100 and the Internet 103. The LAN 100 may be a wireless or wired network.

In the present printing system, a print job is not directly transmitted from the terminal device 130 to the MFP 110. A print job is once transmitted to the cloud server 120 via the Internet 103 and stored in the cloud server 120. The MFP 110 then requests the print job stored in the cloud server 120, and executes the received print job. As employed herein, a print job is data including a command, image data, and print setting information for causing the MFP 110 to perform print processing. For the sake of convenience, the cloud server 120 will hereinafter be described as a virtual printer 120.

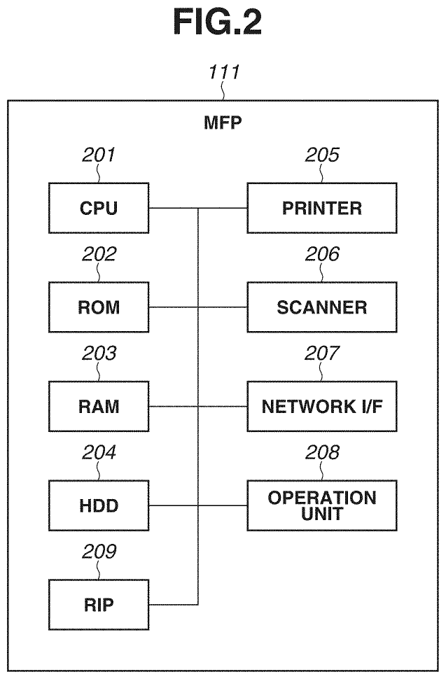

FIG. 2 is a diagram illustrating an example of a hardware configuration of the MFP 111. The MFP 111 includes a central processing unit (CPU) 201, a read-only memory (ROM) 202, a random access memory (RAM) 203, a hard disk drive (HDD) 204, a printer 205, a scanner 206, a network interface (I/F) 207, and an operation unit 208.

The MFP 111 also includes a raster image processor (RIP) 209.

The CPU 201 implements the functions of the MFP 111 by controlling various pieces of hardware 204 to 208 constituting the MFP 111. The CPU 201 transmits signals to the various pieces of hardware 204 to 208 via bus lines and performs mutual data communication with other pieces of hardware.

The ROM 202 stores programs and various types of data to be used by the CPU 201. The RAM 203 is a work memory for temporarily storing programs and data that the CPU 201 uses for calculation. The HDD 204 stores various types of data and various programs. While the MFP 111 according to the present exemplary embodiment is described to use the HDD 204 as an auxiliary storage device, nonvolatile memories such as a solid state drive (SSD) may be used as the auxiliary storage device.

The printer 205 is a unit that implements a print function. The printer 205 performs processing for printing an image on a sheet based on image data included in the print job transmitted from the terminal device 130 via the virtual printer 120. The MFP 110 may include a not-illustrated postprocessing unit that performs postprocessing, such as punching, on a sheet or sheets on which an image or images is/are printed by the printer 205. The postprocessing unit may be connected to a postprocessing apparatus I/F included in the MFP 110 as a postprocessing apparatus that is an external apparatus.

The scanner 206 is a unit that implements a scan function. The scanner 206 performs processing for optically reading a document and converting the read document into image data.

The CPU 201 of the MFP 111 controls operation of the MFP 111 based on a control program in the MFP 111. More specifically, the CPU 201 executes an operating system (OS) for controlling the MFP 111 and a driver program for controlling hardware 1IFs. Application programs running on the OS operate mutually, whereby operation and control of user-desired functions are performed. The OS and various programs are stored in the ROM 202, and read from the ROM 202 into the RAM 203 for execution.

The network I/F 207 of the MFP 111 may be a LAN I/F for wired connection, or may be connected by a Universal Serial Bus (USB)-LAN adaptor. The network I/F 207 may be a LAN I/F for wireless connection.

The network I/F 207 of the MFP 111 is connected to the virtual printer 120 via the LAN 100 and the Internet 103.

The operation unit 208 is a user 1/F for the user of the MFP 1 to use the printer 205 and the scanner 206. For example, the operation unit 208 is a touch panel and accepts operations and inputs. The operation unit 208 can also be used as a display unit that displays information about the MFP 111. The MFP 111 according to the present exemplary embodiment may include an externally-connected operation device and/or display device.

The RIP 209 is a hardware module for performing rasterization processing for rasterizing page description language (PDL) into a raster image. In the present exemplary embodiment, the RIP 209 is described as a built-in hardware module. The RIP 209 may be a software module stored in the ROM 202.

The hardware configuration of the MFP 111 has been described with reference to FIG. 2. The MFP 112 may have hardware configuration similar to that of the MFP 111. For example, a predetermined image forming apparatus capable of Internet Printing Protocol (IPP) communication can be used even with different CPU and/or RAM performance and with different printable sheet sizes.

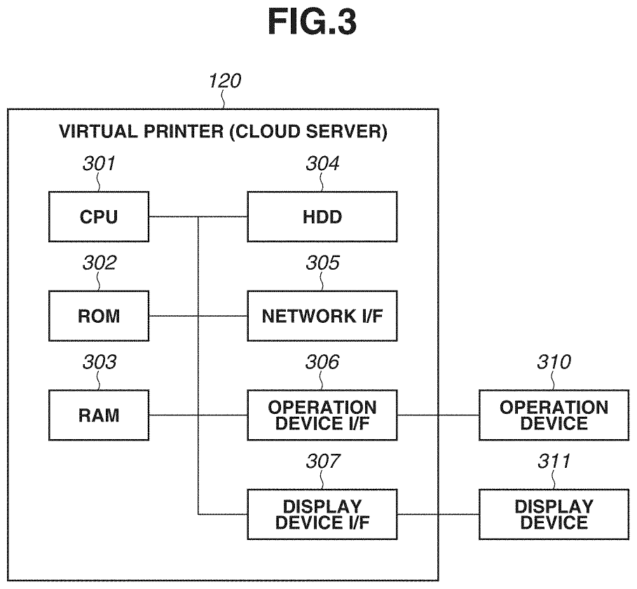

FIG. 3 is a diagram illustrating an example of a hardware configuration of the virtual printer (cloud server) 120. The virtual printer (cloud server) 120 includes a CPU 301, a ROM 302, a RAM 303, an HDD 304, a network I/F 305, an operation device I/F 306, and a display device I/F 307.

The CPU 301 implements the functions of the virtual printer 120 by controlling various pieces of hardware 304 to 307 constituting the virtual printer 120. The CPU 301 transmits signals to the various pieces of hardware 304 to 307 via bus lines and performs mutual data communication with other pieces of hardware.

The ROM 302 stores programs and various types of data to be used by the CPU 301. The RAM 303 is a work memory for temporarily storing programs and data that the CPU 301 uses for calculation. The HDD 304 stores various types of data and various programs. While the virtual printer 120 according to the present exemplary embodiment is described to use the HDD 304 as an auxiliary storage device, nonvolatile memories such as an SSD may be used as the auxiliary storage device.

The network I/F 305 may be a LAN I/F for wired connection, or may be connected by a USB-LAN adaptor. The network I/F 305 may be a LAN I/F for wireless connection.

The network I/F 305 is connected to the MFP 110 and the terminal device 130 via the LAN 100 and the Internet 103.

The operation device I/F 306 is an I/F for connecting the virtual printer 120 with an operation device 310 such as a keyboard and a mouse.

The display device I/F 307 is an I/F for connecting the virtual printer 120 with a display device 311 such as a display.

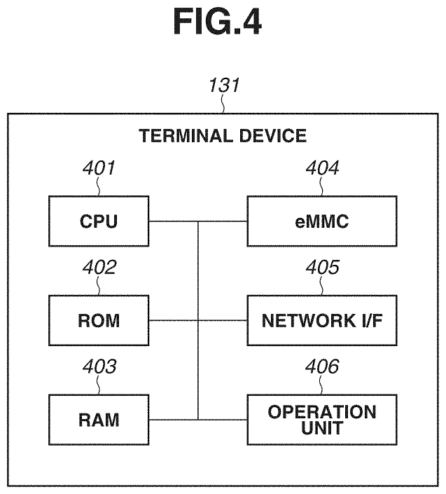

FIG. 4 is a diagram illustrating an example of a hardware configuration of the terminal device 131. The terminal device 131 includes a CPU 401, a ROM 402, a RAM 403, an embedded MultiMediaCard (eMMC) 404, a network I/F 405, and an operation unit 406.

The CPU 401 implements the functions of the terminal device 131 by controlling various pieces of hardware 404 to 406 constituting the terminal device 131. The CPU 401 transmits signals to the various pieces of hardware 404 to 406 via bus lines and performs mutual data communication with other pieces of hardware.

The ROM 402 stores programs and various types of data to be used by the CPU 401. The RAM 403 is a work memory for temporarily storing programs and data that the CPU 401 uses for calculation. The eMMC 404 stores various types of data and various programs.

The network I/F 405 may be a LAN I/F for wired connection, or may be connected by a USB-LAN adaptor. The network I/F 405 may be a LAN I/F for wireless connection.

The network I/F 405 is connected to the virtual printer 120 via the LAN 100 and the Internet 103.

The operation unit 406 is a user interface for the user to use the terminal device 131. For example, the operation unit 406 is a touch panel and accepts operations and inputs. The operation unit 406 can also be used as a display unit for displaying information about the terminal device 131. The terminal device 131 according to the present exemplary embodiment may include an externally-connected operation device and/or display device.

The hardware configuration of the terminal device 131 has been described with reference to FIG. 4. The terminal devices 132 and 133 may have a hardware configuration similar to that of the terminal device 131. The terminal devices 132 and 133 may have a configuration different from that of the terminal device 131 as long as IPP communication can be performed.

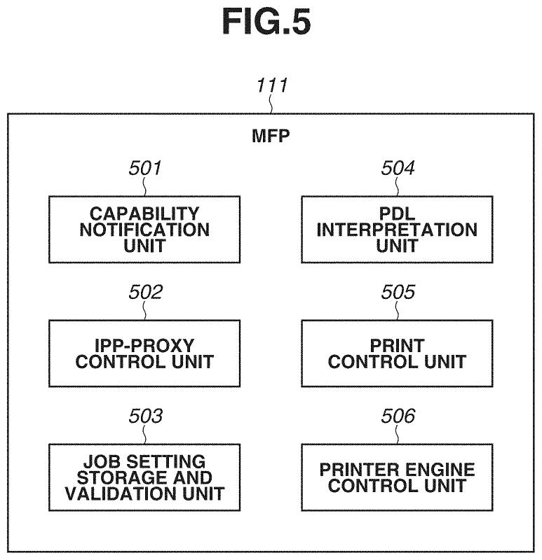

FIG. 5 is a diagram illustrating an example of a software configuration of the MFP 111.

The CPU 201 transmits capability information about the MFP 111 to the virtual printer 120 by running a capability notification unit 501. Examples of the capability information include the following: “copies-supported” indicating the maximum number of copies that can be printed, “document-format-supported” indicating supported formats, and “feed-orientation-supported” indicating information about an optimum feed orientation.

The CPU 201 of the MFP 111 receives a print job from the virtual printer 120 via IPP communication by running an IPP-proxy control unit 502.

The CPU 201 validates attributes of the received print job and stores the attributes in the RAM 203 by running a job setting storage and validation unit 503. Specifically, the CPU 201 checks print settings included in the print job, and stores the print settings in the RAM 203. For example, the CPU 201 checks and stores the number of copies to be printed, executable finishing processes, and PDL format information.

The CPU 201 interprets drawing data included in the received print job by running a PDL interpretation unit 504. The CPU 201 also controls the RIP 209 to perform rasterization processing. The PDL interpretation unit 504 according to the present exemplary embodiment supports the Printer Working Group (PWG)-Raster format.

The CPU 201 performs color separation on the rasterized image data into red (R), green (G) and blue (B) components by running a print control unit 505.

The CPU 201 controls the printer 205 to perform print processing in units of pages based on the color-separated RGB image data and the print settings by running a printer engine control unit 506.

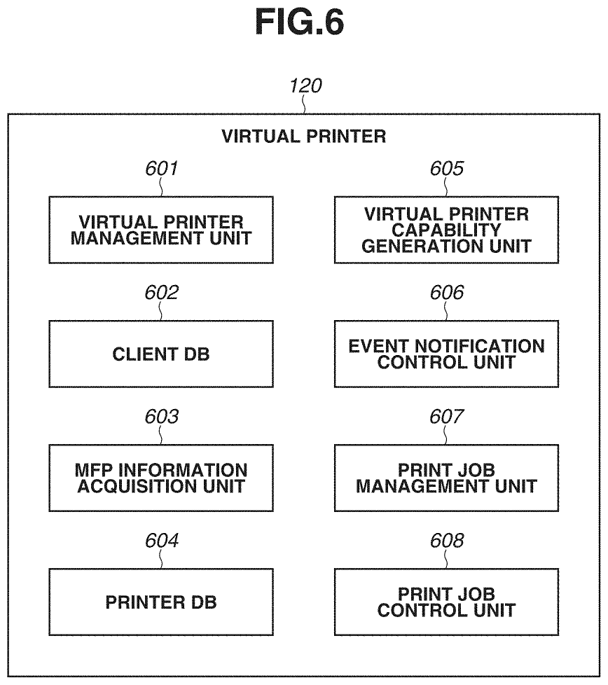

FIG. 6 is a diagram illustrating an example of a software configuration of the virtual printer 120.

The CPU 301 stores client information about the terminal device 130, received by IPP communication, into a client database (DB) 602 in the HDD 304 by running a virtual printer management unit 601. Examples of the client information include an Internet Protocol (IP) address and a port number.

The CPU 301 receives MFP information from the MFPs 110 via IPP communication and stores the MFP information in a printer BD 604 in the HDD 304 by running an MFP information acquisition unit 603. As employed herein, the MFP information includes the identifier of the MFP 110 and the capability information about the MFP 110.

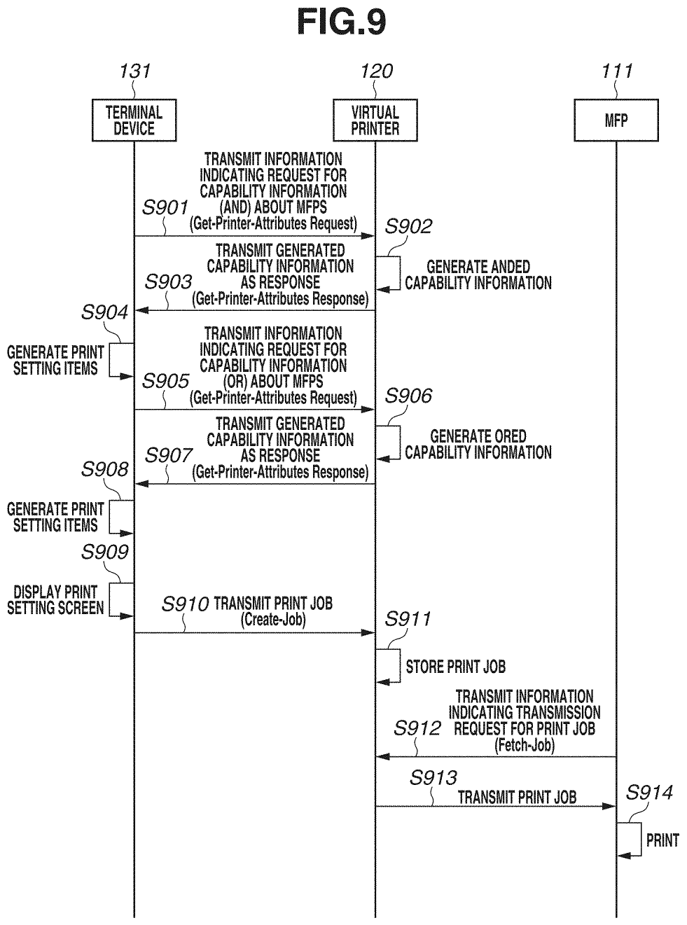

The CPU 301 generates a product set (AND) or sum set (OR) of pieces of capability information about the MFPs stored in the printer DB 604 as capability information about the virtual printer 120 by running a virtual printer capability generation unit 605. Details will be described below with reference to the sequence diagram of FIG. 9.

If the capability information about the virtual printer 120 is reconstructed by the virtual printer capability generation unit 605, the CPU 301 transmits information indicating the update to the terminal device 130 by running an event notification control unit 606. The terminal device 130 receiving the information indicating the update request the capability information about the virtual printer 120 from the virtual printer 120 again.

The CPU 301 stores the print job received from the terminal device 130 in the HDD 304 by running a print job management unit 607.

If a request for a print job is received from an MFP 110 by IPP communication, the CPU 301 transmits the print job stored in the HDD 304 to the MFP 110 by running a print job control unit 608.

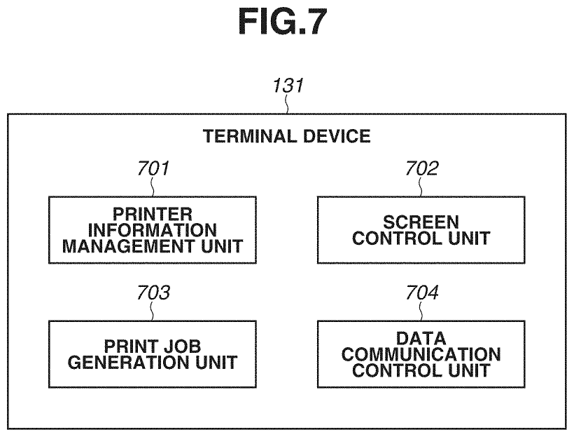

FIG. 7 is a diagram illustrating an example of a software configuration of the terminal device 131.

The CPU 401 of the terminal device 131 transmits a request for the capability information about the virtual printer 120 to the virtual printer 120 and stores received capability information in the RAM 403 by running a printer information management unit 701. Specifically, the CPU 401 requests the capability information obtained by ANDing or ORing the pieces of capability information about the MFPs stored in the printer DB 604 of the virtual printer 120, and stores the received capability information in the RAM 403.

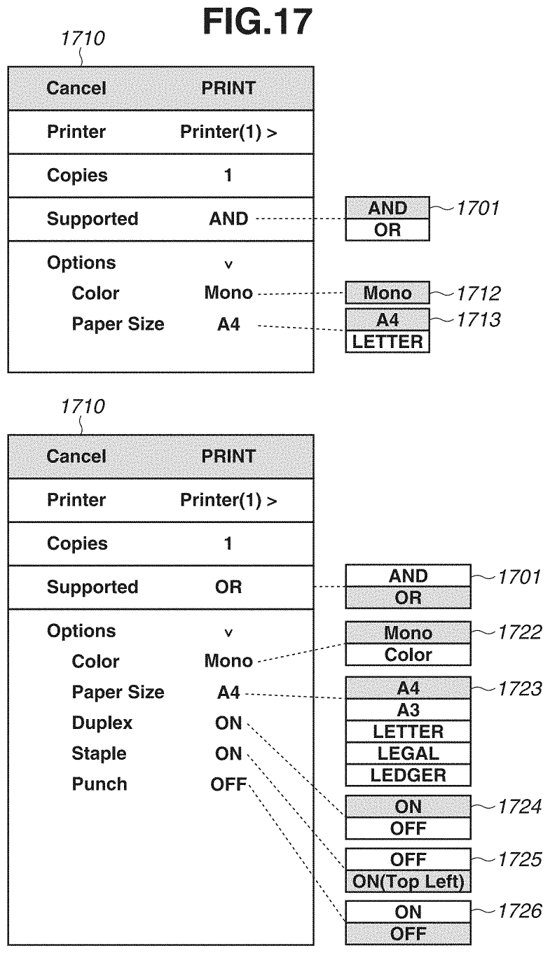

The CPU 401 accepts the user's operations on the operation unit 406 of the terminal device 131 and displays a print setting screen for making print settings by running a screen control unit 702. Details of the print setting screen will be described below with reference to FIG. 17.

The CPU 401 generates a print job based on the print settings accepted on the print setting screen displayed on the operation unit 406 and image data to be printed by running a print job generation unit 703.

The CPU 401 transmits a print job and a request for capability information to the virtual printer 120 by running a data communication control unit 704. The CPU 401 also receives the capability information from the virtual printer 120 by running the data communication control unit 704.

FIG. 17 is a diagram illustrating examples of the print setting screen displayed on a terminal device 130. Screens 1710 and 1720 are print setting screens displayed on the operation unit 406 or display unit of the terminal device 130. Print settings and print instructions can be transmitted to the virtual printer 120 by accepting the user's operations on the print setting screens.

On the screens 1710 and 1720, a printer (1) is selected as a virtualized printer. Virtualized printers can be selected and settings about the number of copies to be printed and supported functions (capabilities) can be made on the screens 1710 and 1720.

On the screen 1710, a Supported button 1701 for selecting the display format of capability information is set to AND. If the user selects the Supported button 1701, AND and OR are toggled to switch the display of the Options field.

On the screen 1720, the Supported button 1701 for selecting the display format of capability information is set to OR.

On the screen 1710, a Color button 1712 in the Options field is set to monochrome printing (Mono). A Paper Size button 1713 is set to A4 selected from between A4 and LETTER.

On the screen 1720, a Color button 1722 in the Options field is set to monochrome printing selected from between monochrome printing (Mono) and color printing (Color). A Paper Size button 1723 is set to A4 selected from among A4, A3, LETTER, LEGAL, and LEDGER. A Duplex button 1724 for setting two-sided printing is set to ON selected from between ON and OFF, i.e., two-sided printing is set to be performed. A Staple button 1725 for setting stapling is set to select ON from between ON (Top Left) and OFF, i.e., stapling is set to be performed. A Punch button 1726 for setting punching is set to select OFF from between ON and OFF, i.e., punching is set not to be performed.

Displaying the product set of pieces of capability information about the plurality of MFPs connected to the virtual printer 120 in making print settings on the print setting screen as illustrated in FIG. 17 provides the following effects. If the capabilities of a certain MFP 110 connected to the virtual printer 120 are not known to the user, printing will not be performed with print settings set beyond the capabilities. For example, suppose that the MFP 111 supports A4 and A3 sizes, and the MFP 112 supports only A4 size. In such a case, the user is prevented from making the MFP 112 perform print processing with the A3 print setting. If the MFP 110 receives a print job including a print setting of a capability not supported by itself, the MFP 110 deletes the print job without executing the print job. This is not restrictive, and the MFP 110 may modify the printing settings of the received print job to the capabilities supported by itself. For example, if an MFP 110 supporting only A4 size receives a print job with a print setting for A3 size, the MFP 110 prints an image on a sheet in A4 size.

Displaying the sum set of pieces of capability information about the plurality of MFPs connected to the virtual printer 120 in making print settings on the print setting screen as in FIG. 17 enables the user to perform a print job at desired print settings if the user knows the capabilities of an MFP.

In the present exemplary embodiment, the product set and sum set of pieces of capability information about the MFPs are described to be switched for display. However, this is not restrictive. For example, either the product set of pieces of capability information about the MFPs or the capability information about the respective MFPs may be displayed.

In a conventional printing system, to calculate the product set of pieces of capability information about a plurality of image forming apparatuses, a terminal device needs to request the image forming apparatuses respective capability information. There has thus been an issue of heavy load on the terminal device.

In view of such an issue, the present exemplary embodiment can reduce the load of the terminal device 130 in requesting the capability information about the plurality of image forming apparatuses to calculate the product set of pieces of capability information about the plurality of image forming apparatuses by performing the following processing.

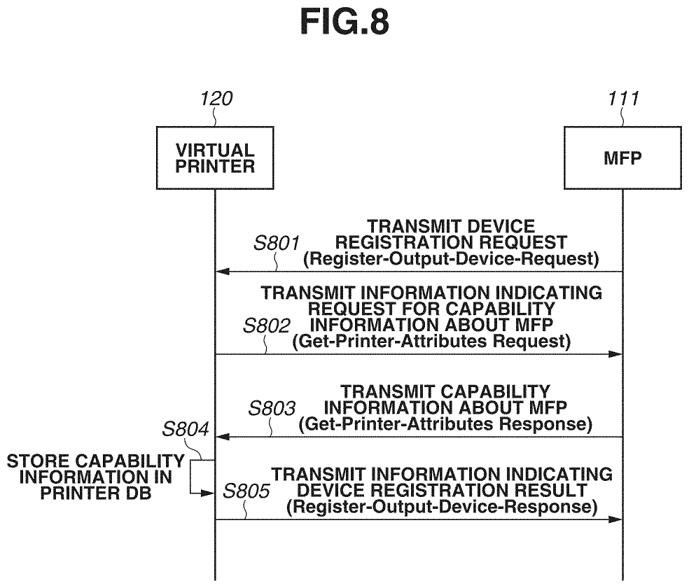

FIG. 8 is a sequence diagram illustrating an example of a sequence in registering the capability information about the MFP 111 in the virtual printer 120. This sequence is started when the user operates the MFP 111 and the MFP 111 accepts an instruction to register the capability information in the virtual printer 120. In the present exemplary embodiment, processing between the virtual printer 120 and the MFP 111 of the MFP 110 will be described as an example.

In step S801, the CPU 201 of the MFP 111 transmits a device registration request (Register-Output-Device-Request) to the virtual printer 120.

In step S802, the CPU 301 of the virtual printer 120 transmits, to the MFP 111 that has transmitted the device registration request, information (Get-Printer-Attributes Request) indicating a request for the capability information about the MFP 111.

In step S803, the CPU 201 of the MFP 111 transmits the capability information about the MFP 111 (Get-Printer-Attributes Response) to the virtual printer 120.

In step S804, the CPU 301 of the virtual printer 120 stores the received capability information about the MFP 111 into the printer DB 604 in the HDD 304.

In step S805, the CPU 301 of the virtual printer 120 transmits information (Register-Output-Device-Response) indicating the device registration result to the MFP 111.

FIG. 9 is a sequence diagram illustrating an example of a sequence when the MFP 111 receiving a print job from the terminal device 131 via the virtual printer 120 executes the print job. This sequence is started by the user's instruction to display a print setting screen on the operation unit 406 of the terminal device 131. In the present exemplary embodiment, processing between the MFP 111 of the MFP 110, the virtual printer 120, and the terminal device 131 of the terminal device 130 will be described as an example.

In step S901, the CPU 401 of the terminal device 131 transmits information (Get-Printer-Attributes Request) indicating a request for capability information (AND) to the virtual printer 120.

In step S902, the CPU 301 of the virtual printer 120 generates capability information that is the product set (AND) of pieces of capability information about the MFPs stored in the printer DB 604. In other words, the CPU 301 generates information about capabilities that all the MFPs of the MFP 110 having transmitted the capability information thereof to the virtual printer 120 have from among the pieces of capability information stored in the printer DB 604.

In step S903, the CPU 301 of the virtual printer 120 transmits the capability information generated in step S902 to the terminal device 131 as a response (Get-Printer-Attributes Response).

In step S904, the CPU 401 of the terminal device 131 generates print setting items to be displayed on the operation unit 406, corresponding to the capability information received in step S903. The CPU 401 stores the print setting items in the RAM 403.

In step S905, the CPU 401 of the terminal device 131 transmits information (Get-Printer-Attributes Request) indicating a request for capability information (OR) to the virtual printer 120.

In step S906, the CPU 301 of the virtual printer 120 generates capability information that is the sum set (OR) of pieces of capability information about the MFPs stored in the printer DB 604. In other words, the CPU 301 generates all information about capabilities that at least any one of the MFPs of the MFP 110 having transmitted the capability information thereof to the virtual printer 120 has from among the pieces of capability information stored in the printer DB 604, as capability information about the virtual printer 120.

In step S907, the CPU 301 of the virtual printer 120 transmits the capability information generated in step S906 to the terminal device 131 as a response (Get-Printer-Attributes Response).

In step S908, the CPU 401 of the terminal device 131 generates print setting items to be displayed on the operation unit 406, corresponding to the capability information received in step S907. The CPU 401 stores the print setting items in the RAM 403.

In step S909, the CPU 401 of the terminal device 131 generates a print setting screen based on the print setting items generated and stored in the RAM 403 in steps S904 and S908, and displays the print setting screen on the operation unit 406 of the terminal device 131.

In step S910, the CPU 401 of terminal device 131 accepts the user's operations on the print setting screen displayed in step S909. The CPU 401 then transmits a print job (Create-Job) including the accepted print settings and image data selected by the user to the virtual printer 120.

In step S911, the CPU 301 of the virtual printer 120 stores the received print job in the HDD 304.

In step S912, if the user's print instruction is accepted via the operation unit 208 of the MFP 111, the CPU 201 of the MFP 111 transmits, to the virtual printer 120, information (Fetch-Job) indicating a transmission request for the print job corresponding to the print instruction.

In step S913, the CPU 301 of the virtual printer 120 transmits the print job to the MFP 111.

In step S914, the CPU 201 of the MFP 111 controls the printer 205 to print an image on a sheet based on the image data and print settings included in the received print job.

In the present exemplary embodiment, the terminal device 131 requests and obtains both the ANDed capability information and the ORed capability information about the MFP 110 before displaying the print setting screen. However, this is not restrictive. For example, the terminal device 131 may request of the virtual printer 120 either selected one of the ANDed capability information and the ORed capability information when the Supported button 1701 is selected by the user on the print setting screen on the terminal device 131.

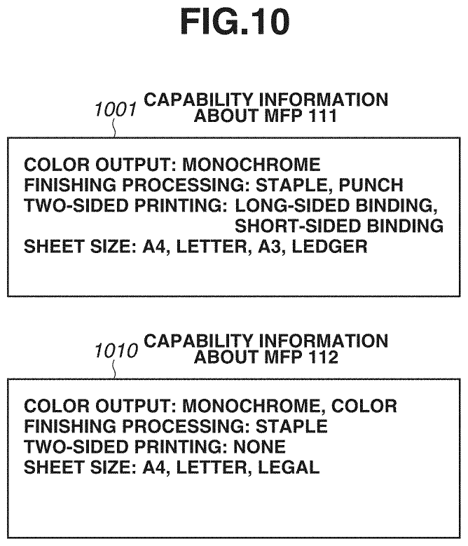

FIG. 10 is a diagram illustrating examples of the capability information about the MFP 110. Capability information 1001 represents the capability information about the MFP 111. The capability information is information indicating the functions supported by the MFP 111. The MFP 111 has the following capabilities, i.e., supports the following: for color output, only “monochrome” printing; for finishing processes, “staple”, and “punch”; and for two-sided printing, “long-edge binding”, and “short-edge binding”. For sheet sizes, sheets of “A4”, “LETTER”, “A3”, and “LEDGER” sizes are supported.

The capabilities of the MFP 112 are as follows: for color output, “monochrome, color”; for finishing processes, “staple”; for two-sided printing, “none”; and for sheet sizes, sheets of “A4”, “LETTER”, and “LEGAL” sizes.

For example, the product set (AND) of pieces of capability information about the two MFPs 111 and 112, obtained in step S902, will be described. The product set of pieces of capability information is information indicating the capabilities that all of the MFPs of the MFP 110 having transmitted the capability information thereof to the virtual printer 120 have. The ANDed capability information indicates that the following are supported: for color output, only “monochrome” printing; for finishing processes, “staple”; for two-sided printing, “none”; and for sheet sizes, “A4”, and “LETTER” sizes.

The sum set (OR) of pieces of capability information about the two MFPs 111 and 112, obtained in step S906, will be described. The sum set of pieces of capability information is information indicating capabilities that at least either one of the MFPs of the MFP 110 which has transmitted the capability information thereof to the virtual printer 120 has. The ORed capability information indicates that the following are supported: for color output, “monochrome, color”; for finishing processes, “staple, punch”; for two-sided printing, “long-edge binding”, and “short-edge binding”; and for sheet sizes, sheets of “A4”, “LETTER”, “LEGAL”, “A3”, and “LEDGER” sizes.

The capabilities described above are merely examples. Other examples may include automatic two-sided print processing, printing resolution, N-in-one layout processing by a printing apparatus, and image rotation processing.

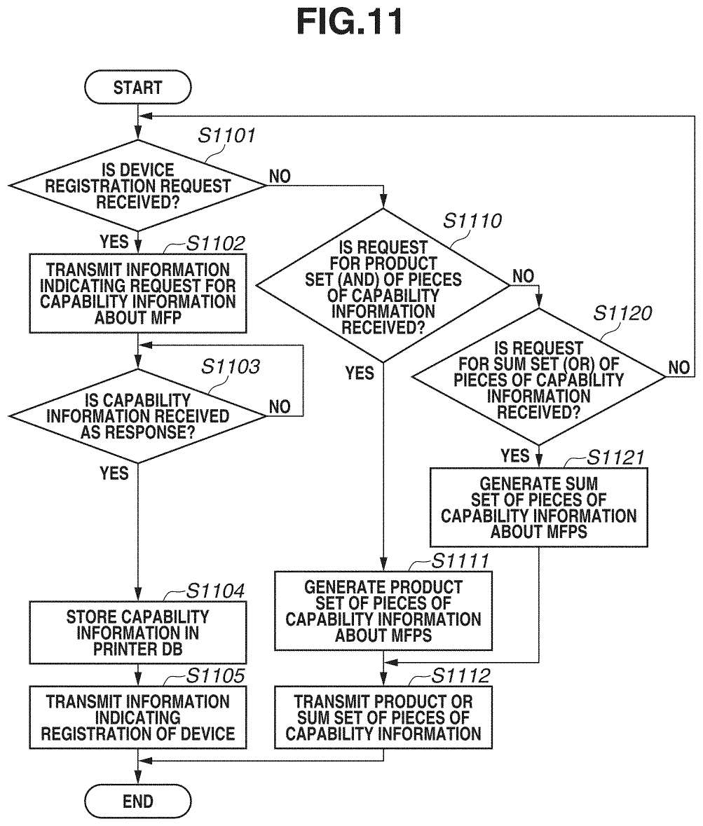

FIG. 11 is a flowchart illustrating an example of processing performed by the virtual printer 120. The processing of the flowchart of FIG. 11 is implemented by the CPU 301 reading a program stored in the ROM 302 into the RAM 303 and executing the program. The processing of the flowchart of FIG. 11 is started in response to connection of the virtual printer 120 to the MFP 110 via the network I/F 305.

In step S1101, the CPU 301 of the virtual printer 120 determines whether a device registration request (Register-Output-Device-Request) is received from the MFP 110. If the device registration request is determined to be received (YES in step S1101), the processing proceeds to step S1102. If the device registration request is determined to be not received (NO in step S1101), the processing proceeds to step S1110.

In step S1102, the CPU 301 transmits information (Get-Printer-Attributes Request) indicating a request for capability information about the MFP 110 having transmitted the device registration request to the MFP 110.

In step S1103, the CPU 301 determines whether capability information is received from the MFP 110 as a response (Get-Printer-Attributes Response). If the capability information is determined to be received (YES in step S1103), the processing proceeds to step S1104. If the capability information is determined to be not received (NO in step S1103), the processing returns to step S1103.

In step S1104, the CPU 301 stores the capability information received in step S1103 into the printer DB 604 in the HDD 304.

In step S1105, the CPU 301 transmits information (Register-Output-Device-Response) indicating the registration of the device (MFP 110) to the MFP 110 having transmitted the device registration request. The processing is ended.

A case where no device registration request is determined to be received in step S1101 and the processing proceeds to S1110 will be described.

In step S110, the CPU 301 determines whether a request (Get-Printer-Attributes Request) for a product set (AND) of pieces of capability information is received from a terminal device 130. If the request is determined to be received (YES in step S1110), the processing proceeds to step S1111. If the request is determined to be not received (NO in step S1110), the processing proceeds to step S1120.

In step S1111, the CPU 301 generates the product set of pieces of capability information based on the pieces of capability information about the MFPs stored in the printer DB 604 in the HDD 304.

In step S1120, the CPU 301 determines whether a request (Get-Printer-Attributes Request) for a sum set (OR) of pieces of capability information is received from the terminal device 130. If the request is determined to be received (YES in step S1120), the processing proceeds to step S1121. If the request is determined to be not received (NO in step S1120), the processing returns to step S1101.

In step S1121, the CPU 301 generates the sum set of pieces of capability information from the pieces of capability information about the MFPs stored in the printer DB 604 in the HDD 304.

In step S1112, the CPU 301 transmits the product set or sum set of pieces of capability information as a response (Get-Printer-Attributes Response) to the terminal device 130 transmitting the request for capability information. The processing is ended.

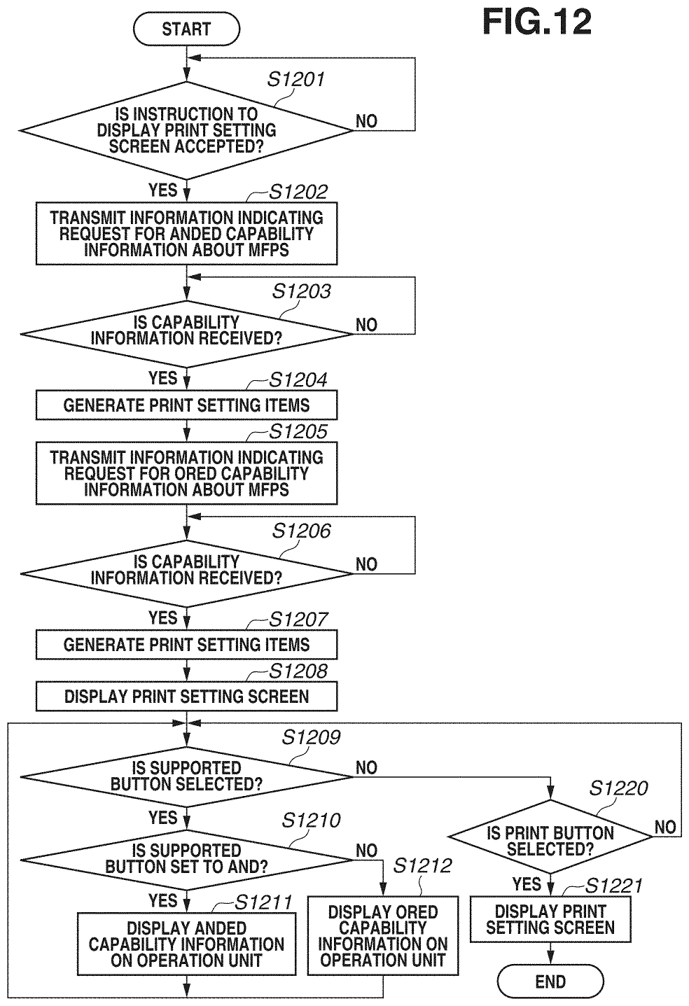

FIG. 12 is a flowchart illustrating an example of processing performed by a terminal device 130. The processing of the flowchart of FIG. 12 is implemented by the CPU 401 reading a program stored in the ROM 402 into the RAM 403 and executing the program. The processing of the flowchart of FIG. 12 is started in response to power-on of the terminal device 130.

In step S1201, the CPU 401 determines whether the operation unit 406 is operated by the user and an instruction to display the print setting screen is accepted. If the instruction is determined to be accepted (YES in step S1201), the processing proceeds to step S1202. If the instruction is determined to be not accepted (NO in step S1201), the processing returns to step S1201.

In step S1202, the CPU 401 transmits, to the virtual printer 120, information (Get-Printer-Attributes Request) indicating a request for the ANDed capability information about the MFP 110.

In step S1203, the CPU 401 determines whether the ANDed capability information about the MFP 110 is received from the virtual printer 120 as a response (Get-Printer-Attributes Response). If the capability information is determined to be received (YES in step S1203), the processing proceeds to step S1204. If the capability information is determined to be not received (NO in step S1203), the processing returns to step S1203.

In step S1204, the CPU 401 generates print setting items to be displayed on the operation unit 406, corresponding to the received capability information. The CPU 401 stores the print setting items in the RAM 403.

In step S1205, the CPU 401 transmits information (Get-Printer-Attributes Request) indicating a request for the ORed capability information about the MFP 110 to the virtual printer 120.

In step S1206, the CPU 401 determines whether the ORed capability information about the MFP 110 is received from the virtual printer 120 as a response (Get-Printer-Attributes Response). If the capability information is determined to be received (YES in step S1206), the processing proceeds to step S1207. If the capability information is determined to be not received (NO in step S1206), the processing returns to step S1206.

In step S1207, the CPU 401 generates print setting items to be displayed on the operation unit 406, corresponding to the received capability information. The CPU 401 stores the print setting items in the RAM 403.

In step S1208, the CPU 401 displays a print setting screen, as illustrated in FIG. 17, generated based on the print setting items stored in the RAM 403 on the operation unit 406.

In step S1209, the CPU 401 determines whether the Supported button 1701 on the print setting screen is selected by the user. If the Supported button 1701 is determined to be selected (YES in step S1209), the processing proceeds to step S1210. If the Supported button 1701 is determined to be not selected (NO in step S1209), the processing proceeds to step S1220.

In step S1210, the CPU 401 determines whether the Supported button 1701 is set to AND by the user via the operation unit 406. If the Supported button 1701 is set to AND (YES in step S1210), the processing proceeds to step S1211. If the Supported button 1701 is set to OR (NO in step S1210), the processing proceeds to step S1212.

In step S1211, the CPU 401 displays the ANDed capability information stored in the RAM 403 on the operation unit 406.

In step S1212, the CPU 401 displays the ORed capability information stored in the RAM 403 on the operation unit 406.

In step S1220, the CPU 401 determines whether a print button on the print setting screen is selected by the user. If the print button is determined to be selected (YES in step S1220), the processing proceeds to step S1221. If the print button is determined to be not selected (NO in step S1220), the processing returns to step S1209.

In step S1221, the CPU 401 transmits a print job (Create-Job) including image data selected by the user in advance and the print settings made on the print setting screen to the virtual printer 120. The processing is ended.

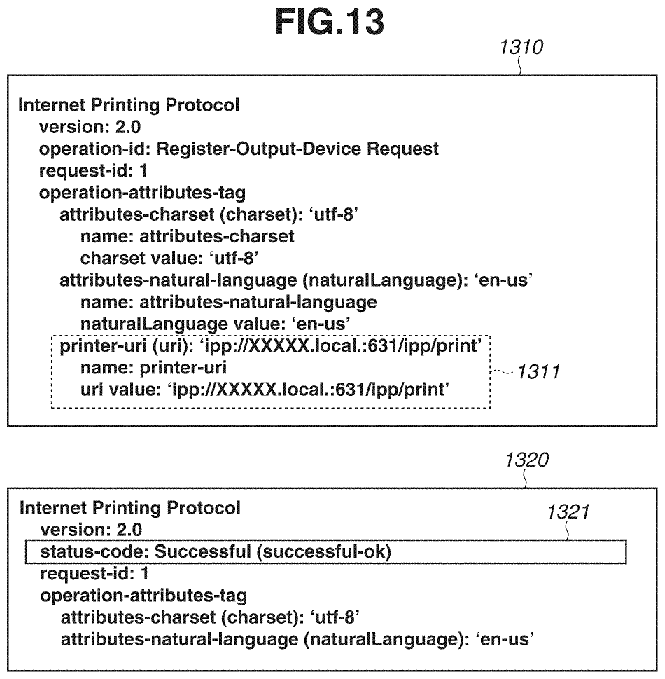

FIGS. 13 to 16 illustrate examples of IPP communication messages exchanged between the MFP 110, the virtual printer 120, and the terminal device 130.

FIG. 13 is a diagram illustrating examples of messages in transmitting a device registration request and a registration result notification by IPP communication between the MFP 110 and the virtual printer 120.

A message 1310 is an example of the message when the MFP 110 transmits a device registration request (Register-Output-Device-Request) to the virtual printer 120.

The message includes Hypertext Transfer Protocol (HTTP) layer header information and IPP message data on the HTTP. IPP message data 1311 includes “ipp://XXXXX.local.:631/ipp/print”, which is an identifier of the MFP 110. The virtual printer 120 transmits a request for capability information and a registration result notification to the MFP 110 corresponding to the identifier in the IPP message data 1311.

A message 1320 is an example of the message when the virtual printer 120 transmits a registration result notification (Register-Output-Device-Response) to the MFP 110. IPP message data 1321 “status-code: Successful (successful-ok)” indicates that the virtual printer 120 has registered the device (MFP 110).

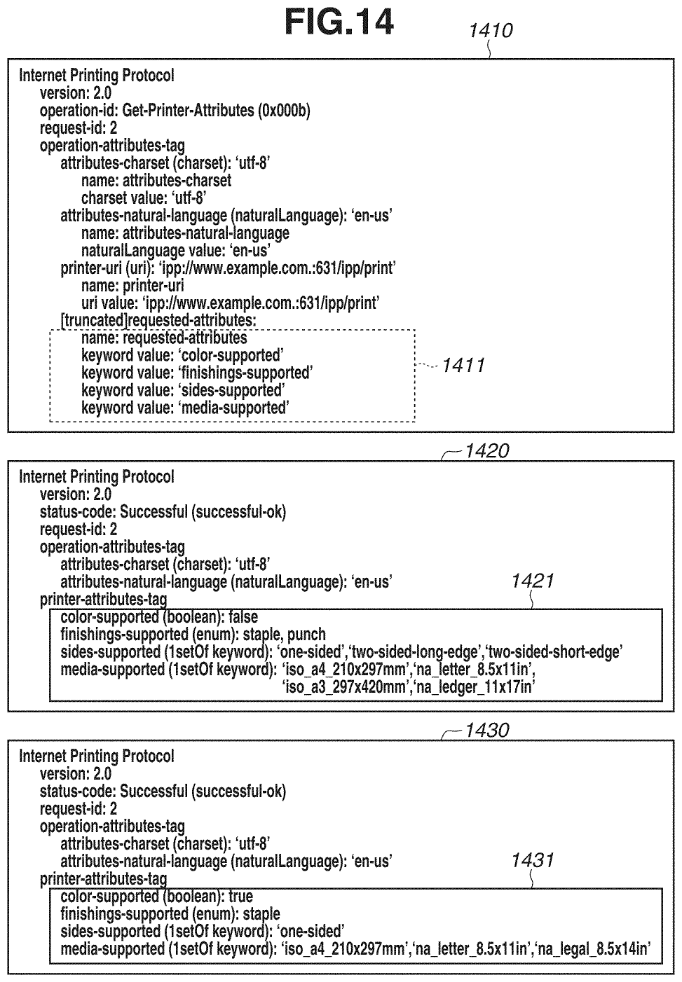

FIG. 14 illustrates examples of messages about a capability information request that the virtual printer 120 transmits to the MFP 110 by IPP communication and capability information that the MFP 110 transmits to the virtual printer 120 by IPP communication.

A message 1410 is an example of the message when the virtual printer 120 transmits a capability information request (Get-Printer-Attributes Request) to the MFP 110.

IPP message data 1411 specifies the types of capabilities requested of the MFP 110.

The keyword “keyword value: ‘color-supported’” is a keyword requesting attributes about whether color printing is supported. The keyword “keyword value: ‘finishings-supported’” is a keyword requesting attributes about whether finishing processes are supported. The keyword “keyword value: ‘sides-supported’” is a keyword requesting attributes about whether two-sided printing is supported. The keyword “keyword value: ‘media-supported’” is a keyword requesting attributes about the types of sheets supported.

Messages 1420 and 1430 are examples of the message when the MFP 110 transmits capability information (Get-Printer-Attributes Response) to the virtual printer 120.

IPP message data 1421 in the message 1420 describes the capabilities of the MFP 111. The respective attributes indicate capabilities as follows. The string “color-supported (boolean): false” indicates that only monochrome printing is supported. The string “finishing-supported (enum): staple, punch” indicates that stapling and punching are supported as finishing processes. The string “sides-supported (1setOf keyword): ‘one-sided’, ‘two-sided-long-edge’, ‘two-sided-short-edge’” indicates that long-edge binding and short-edge binding are available during two-sided printing. That A4, LETTER, A3, and LEDGER sheet sizes are supported is expressed as follows: “media-supported (1setOf keyword): ‘iso_a4_210×297 mm’, ‘na_letter_8.5×11 in’, ‘iso_a3_297×420 mm’, ‘na_ledger_11×17in’”.

IPP message data 1431 in the message 1430 describes the capabilities of the MFP 112. The respective attributes indicate capabilities as follows. The string “color-supported (boolean): true” indicates that monochrome printing and color printing are supported. The string “finishings-supported (enum): none” indicates that no finishing process is supported. The string “sides-supported (1setOf keyword): ‘one-sided’” indicates that two-sided printing is not supported.

That A4, LETTER, and LEGAL sheet sizes are supported is expressed as follows: “media-supported (1setOf keyword): ‘iso_a4_210×297 mm’, ‘na_letter_8.5×11 in’, ‘na_legal_8.5×14in’”.

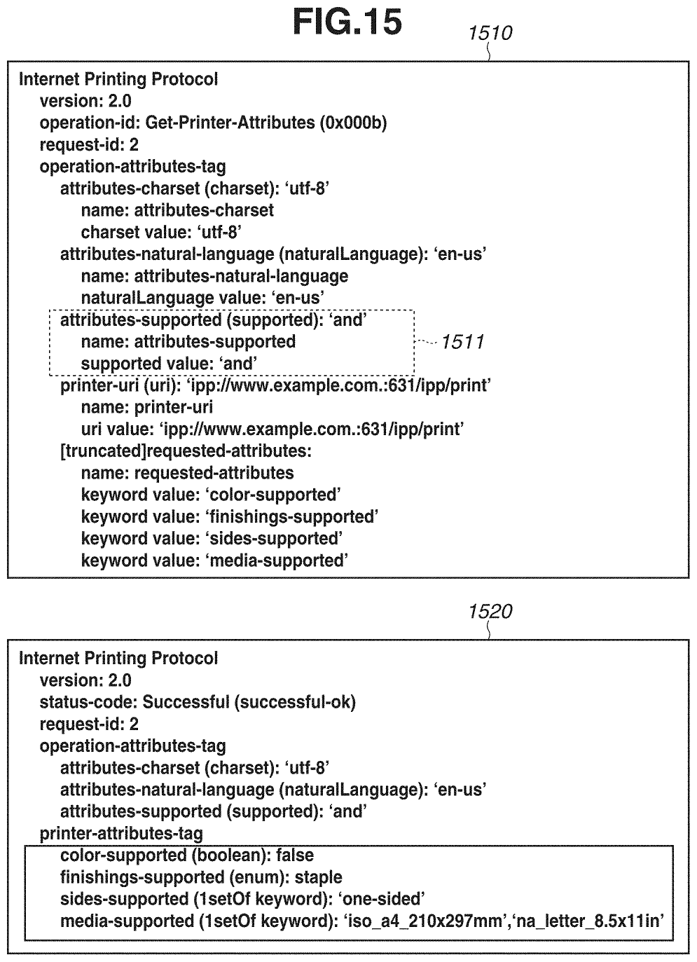

FIG. 15 illustrates examples of messages about a capability information request that a terminal device 130 transmits to the virtual printer 120 by IPP communication and capability information that the virtual printer 120 transmits to the terminal device 130 by IPP communication.

A message 1510 is an example of the message when the terminal device 130 transmits a request (Get-Printer-Attributes Request) for ANDed capability information to the virtual printer 120.

IPP message data 1511 in the message 1510 indicates that the request is one for capability information about the capabilities that all the MFPs registered in the virtual printer 120 support.

A message 1520 is an example of the message when the virtual printer 120 transmits the ANDed capability information as a response (Get-Printer-Attributes Response) to the message 1510. IPP message data 1521 in the message 1520 describes attributes indicating the capabilities supported by all the MFPs registered in the virtual printer 120. The respective attributes indicate capabilities as follows.

The string “color-supported (boolean): false” indicates that color printing is not supported. The string “finishings-supported (enum): none” indicates that no finishing process is available. The string “sides-supported (1setOf keyword): ‘one-sided’” indicates that two-sided printing is not supported.

The string “media-supported (1setOf keyword): ‘iso_a4_210×297 mm’, ‘na_letter_8.5×11 in’” indicates that A4 and LETTER sheet sizes are supported.

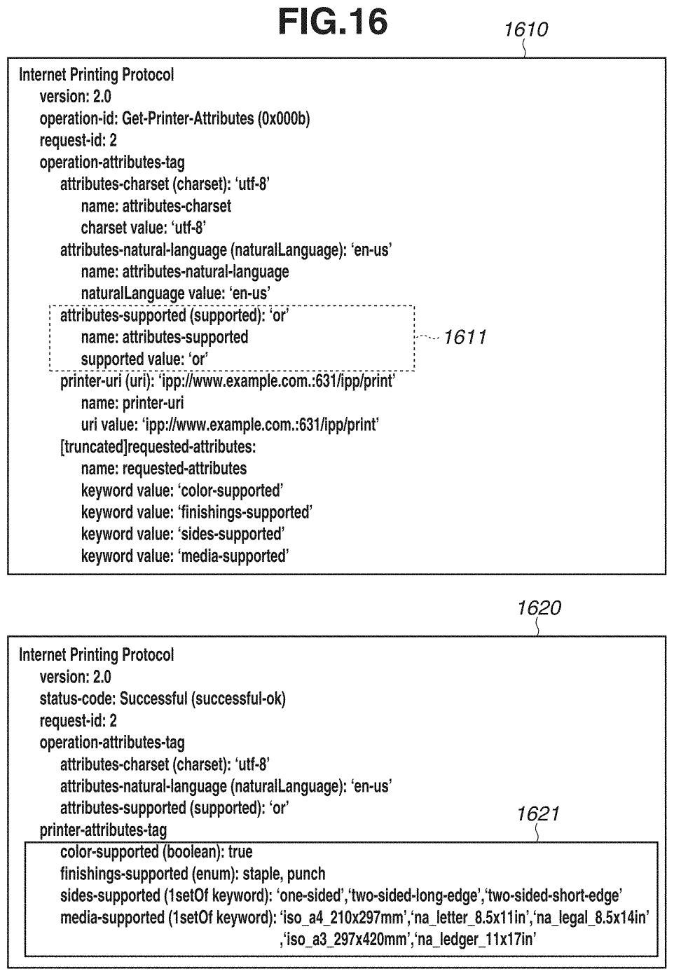

FIG. 16 illustrates examples of messages about a capability information request that the terminal device 130 transmits the virtual printer 120 by IPP communication and capability information that the virtual printer 120 transmits to the terminal device 130 by PP communication.

A message 1610 is an example of the message when the terminal device 130 transmits a request (Get-Printer-Attributes Request) for ORed capability information to the virtual printer 120.

IPP message data 1611 in the message 1610 indicates that the request is one for capability information about capabilities that at least any one of the MFPs registered in the virtual printer 120 supports.

A message 1620 is an example of the message when the virtual printer 120 transmits the ORed capability information as a response (Get-Printer-Attributes Response) to the message 1610. IPP message data 1621 in the message 1620 describes attributes indicating capabilities that at least any one of the MFPs registered in the virtual printer 120 supports. The respective attributes indicate capabilities as follows. The string “color-supported (boolean): true” indicates that color printing is supported. The string “finishings-supported (enum): staple, punch” indicates that stapling and punching are supported as finishing processes. The string “sides-supported (1setOf keyword): ‘one-sided’, ‘two-sided-long-edge’, ‘two-sided-short-edge’” indicates that two-sided printing can be performed with long-edge binding and short-edge binding.

That A4, LETTER, LEGAL, A3, and LEDGER sheet sizes are supported is expressed as follows: “media-supported (1setOf keyword): ‘iso_a4_210×297 mm’, ‘na_letter_8.5×11 in’, ‘na_legal_8.5×14in’, ‘iso_a3_297×420 mm’, ‘na_ledger_11×17in’”.

By such control, the load on the terminal device 130 can be reduced in requesting capability information about a plurality of image forming apparatuses to calculate the product set and sum set of pieces of capability information about the plurality of image forming apparatuses.

A second exemplary embodiment will be described below. In the first exemplary embodiment, the terminal device 130 is described to receive both the ANDed and ORed capability information and display, on the operation unit of the terminal device 130, capability information selected on the print setting screen by the user. In the second exemplary embodiment, a case where an administrator user of the virtual printer can make a setting about which of ANDed capability information and ORed capability information to be transmitted, and either one type of capability information is displayed on the operation unit of the terminal device 130 based on the setting will be described mainly in terms of differences from the first exemplary embodiment.

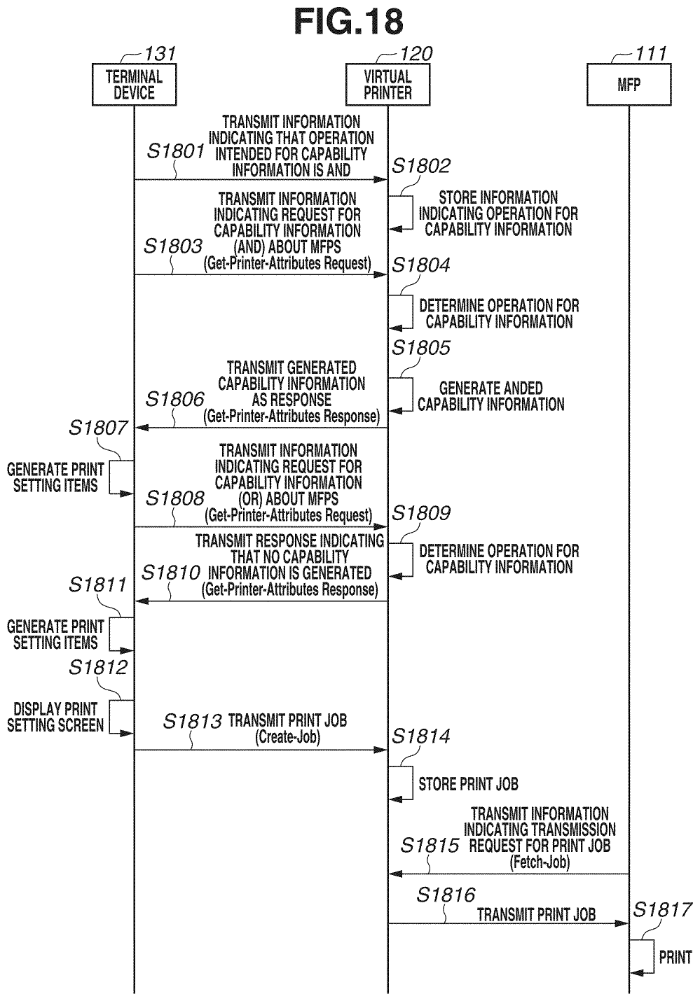

FIG. 18 is a sequence diagram illustrating an example of a sequence when the MFP 111 receiving a print job from a terminal device 131 via the virtual printer 120 executes the print job.

In step S1801, the administrator user sets AND for a setting to obtain capability information from the virtual printer 120. A CPU 401 of the terminal device 131 transmits information indicating that the operation intended for capability information is AND to the virtual printer 120.

In step S1802, a CPU 301 of the virtual printer 120 stores the received information indicating the operation for the capability information in a RAM 303.

In step S1803, the user gives an instruction to display a print setting screen on an operation unit 406 of the terminal device 131. The CPU 401 of the terminal device 131 performs processing similar to that of step S901 based on the instruction.

In step S1804, the CPU 301 of the virtual printer 120 determines whether the operation for the capability information which is indicated by the information stored in the RAM 303 in step S1802 is AND.

In step S1805, the CPU 301 of the virtual printer 120 generates capability information that is the product set (AND) of pieces of capability information about the MFPs stored in a printer DB 604 since the operation for capability information which is indicated by the information stored in the RAM 303 is AND.

In step S1806, the CPU 301 of the virtual printer 120 transmits the generated capability information to the terminal device 131 as a response (Get-Printer-Attributes Response).

In step S1807, the CPU 401 of the terminal device 131 generates print setting items to be displayed on the operation unit 406, corresponding to the capability information received in step S1806. The CPU 401 stores the print setting items in the RAM 403.

In step S1808, the CPU 401 of the terminal device 131 transmits information (Get-Printer-Attributes Request) indicating a request for capability information (OR) to the virtual printer 120.

In step S1809, the CPU 301 of the virtual printer 102 determines whether the operation for the capability information which is indicated by the information stored in the RAM 303 in step S1802 is OR.

In step S1810, the CPU 301 of the viral printer 120 transmits the following response (Get-Printer-Attributes Response) to the request to the terminal device 130. The response includes “status-code: Error (server-error-operation-not-supported)” indicating that no capability information is generated.

In step S1811, the CPU 401 of the terminal device 131 generates blank print setting items to be displayed on the operation unit 406, corresponding to the absence of the ORed capability information. The CPU 401 stores the print setting items in the RAM 403.

The processing of steps S1812 to S1817 is similar to that of steps S909 to S914. A description thereof will thus be omitted.

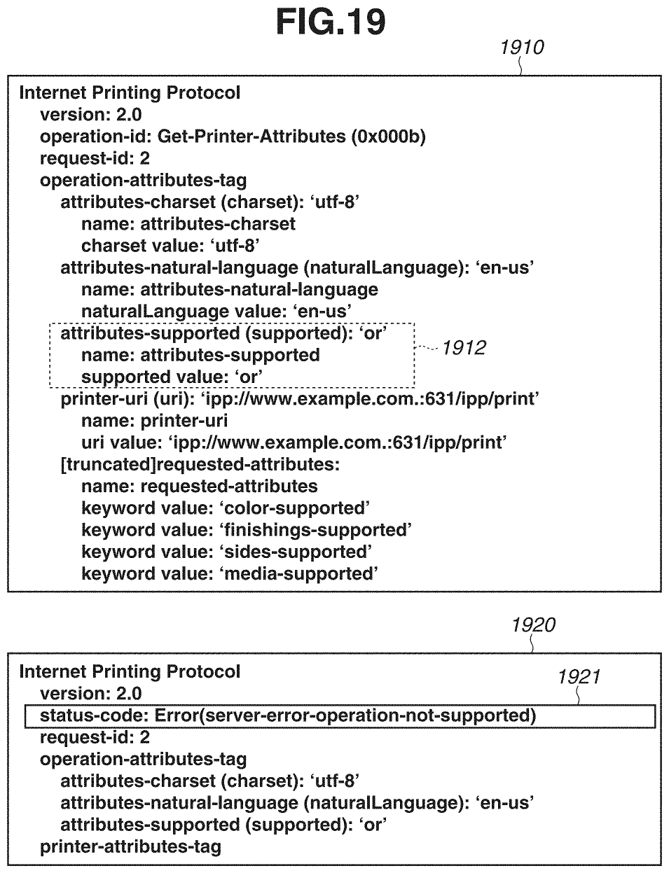

FIG. 19 is a diagram illustrating examples of a message indicating a request for capability information about the MFP 110 that the terminal device 130 transmits to the virtual printer 120 by IPP communication and a message indicating that no capability information is generated, which the virtual printer 120 transmits to the terminal device 130 by IPP communication.

A message 1910 is similar to the message 1610 illustrated in FIG. 16. A description thereof will thus be omitted.

A message 1920 is an example of the message transmitted by the virtual printer 120 as the response (Get-Printer-Attributes Response) to the message 1910 when the virtual printer 120 does not generate ORed capability information. IPP message data 1921 in the message 1920 indicates that the generation of ORed capability information is not supported.

By such processing, either of the product set of pieces of capability information and the sum set of pieces of capability information which is set by the administrator user can be displayed on the print setting screen.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2018-171937, filed Sep. 13, 2018, which is hereby incorporated by reference herein in its entirety.

What is claimed is:

1. A printing system comprising:
a plurality of predetermined image forming apparatuses;
an information processing apparatus; and
an external apparatus,
wherein the information processing apparatus includes
a first reception unit configured to receive capability information transmitted from each of the plurality of predetermined image forming apparatuses, the capability information indicating capabilities that a respective one of the plurality of predetermined image forming apparatuses has, and
a storage unit configured to store the capability information received by the first reception unit,
wherein the external apparatus includes
a display unit configured to display a print setting for accepting a setting based on the capability information, and
a request unit configured to request the information processing apparatus capability information indicating a capability that all the plurality of predetermined image forming apparatuses has,
wherein the information processing apparatus further includes a first transmission unit configured to transmit the capability information based on a request from the request unit, and
wherein the display unit is configured to display the capability information indicating the capability that all the plurality of predetermined image forming apparatuses has.

2. The printing system according to claim 1,
wherein the request unit is configured to request the information processing apparatus at least either one of the capability information indicating the capability that all the plurality of predetermined image forming apparatuses has and capability information indicating capabilities that at least one of the plurality of predetermined image forming apparatuses has, and
wherein the external apparatus includes an instruction unit configured to cause a user to instruct which of the capability information indicating the capability that all the plurality of predetermined image forming apparatuses has or the capability information indicating the capability that at least one of the plurality of predetermined image forming apparatuses has to be displayed on the display unit.

3. The printing system according to claim 1,
wherein the external apparatus further includes a second transmission unit configured to transmit a print job including the print setting displayed on the display unit to the information processing apparatus,
wherein the information processing apparatus further includes a storage unit configured to store the print job transmitted by the second transmission unit, and
wherein the plurality of predetermined image forming apparatuses each includes
a second reception unit configured to receive the print job stored in the storage unit, and
a print unit configured to print an image on a sheet based on the print job received by the second reception unit.

4. The printing system according to claim 3, wherein the print unit in each of the image forming apparatuses is configured to, if at least any one of capabilities needed to print the image on the sheet based on the print job is not included in the capabilities of the image forming apparatus receiving the print job, not print the image on the sheet based on the print job.

5. The printing system according to claim 1, wherein the capability information includes at least any one of the following: information indicating whether color output is supported, information indicating a supported sheet size, information indicating whether two-sided printing is supported, and information indicating an executable finishing process.

6. The printing system according to claim 1, wherein the plurality of predetermined image forming apparatuses is image forming apparatuses supporting a predetermined printing protocol.

7. The printing system according to claim 6, wherein the predetermined printing protocol is the Internet Printing Protocol (IPP).

8. An information processing apparatus configured to be connected to a plurality of predetermined image forming apparatuses and an external apparatus, the information processing apparatus comprising:
a first reception unit configured to receive capability information indicating capabilities of each of the plurality of predetermined image forming apparatuses from a respective one of the plurality of predetermined image forming apparatuses;
a storage unit configured to store the capability information received by the first reception unit;
a second reception unit configured to receive a request from the external apparatus; and
a first transmission unit configured to transmit capability information indicating a capability that all the plurality of predetermined image forming apparatus has to the external apparatus based on the request received by the second reception unit, the capability information being included in the capability information received by the first reception unit.

9. The information processing apparatus according to claim 8, wherein the first transmission unit is configured to transmit, to the external apparatus, at least either one of the capability information indicating the capability that all the plurality of predetermined image forming apparatuses has and capability information indicating capabilities that at least one of the plurality of predetermined image forming apparatuses has, both being included in the capability information received by the first reception unit, based on the request received by the second reception unit.

10. The information processing apparatus according to claim 8, further comprising:
a third reception unit configured to receive a print job transmitted from the external apparatus;
a storage unit into which the third reception unit stores the print job; and
a second transmission unit configured to transmit the print job to the image forming apparatuses based on a request from the image forming apparatuses.

11. The information processing apparatus according to claim 8, wherein the capability information includes at least one of the following: information indicating whether color output is supported, information indicating a supported sheet size, information indicating whether two-sided printing is supported, and information indicating an executable finishing process.

12. The information processing apparatus according to claim 8, wherein the plurality of predetermined image forming apparatuses is image forming apparatuses supporting a predetermined printing protocol.

13. The information processing apparatus according to claim 12, wherein the predetermined printing protocol is the IPP.

14. An external apparatus configured to be connected to an information processing apparatus configured to receive capability information indicating capabilities of each of a plurality of predetermined imaging apparatuses, the external apparatus comprising:
a display unit configured to display the capability information as a print setting; and
a request unit configured to request the information processing apparatus capability information indicating a capability that all the plurality of predetermined image forming apparatuses has,
wherein the display unit is configured to display the capability information indicating the capability that all the plurality of predetermined image forming apparatuses has.

15. The external apparatus according to claim 14,
wherein the request unit is configured to request the information processing apparatus at least either one of the capability information indicating the capability that all the plurality of predetermined image forming apparatuses has and capability information indicating capabilities that at least one of the plurality of predetermined image forming apparatuses has, and
wherein the external apparatus comprises an instruction unit configured to cause a user to instruct which of the capability information indicating the capability that all the plurality of predetermined image forming apparatuses has or the capability information indicating the capabilities that at least one of the plurality of predetermined image forming apparatuses has to be displayed on the display unit.

16. The external apparatus according to claim 14, further comprising a transmission unit configured to transmit a print job including the print setting displayed on the display unit to the information processing apparatus.

17. The external apparatus according to claim 14, wherein the capability information includes at least any one of the following: information indicating whether color output is supported, information indicating a supported sheet size, information indicating whether two-sided printing is supported, and information indicating an executable finishing process.

18. The external apparatus according to claim 14, wherein the plurality of predetermined image forming apparatuses is image forming apparatuses supporting a predetermined printing protocol.

19. The external apparatus according to claim 18, wherein the predetermined printing protocol is the IPP.

20. A method of controlling an information processing apparatus configured to be connected to a plurality of predetermined image forming apparatuses and an external apparatus, the method comprising:
receiving capability information indicating capabilities of each of the plurality of predetermined image forming apparatuses from a respective one of the plurality of predetermined image forming apparatuses;
storing the received capability information;
receiving a request from the external apparatus;
transmitting capability information indicating a capability that all the plurality of predetermined image forming apparatuses has to the external apparatus based on the received request, the capability information being included in the received capability information.

21. A method of controlling an external apparatus configured to be connected to an information processing apparatus configured to receive capability information indicating capabilities of each of a plurality of predetermined image forming apparatuses, the method comprising:
displaying the capability information as a print setting; and
requesting the information processing apparatus capability information indicating a capability that all the plurality of predetermined image forming apparatuses has,
wherein the displaying includes displaying the capability information indicating the capability that all the plurality of predetermined image forming apparatuses has.

22. A non-transitory computer-readable storage medium storing a program that, when executed by a computer, causes the computer to perform a method of controlling an information processing apparatus, the method comprising:
receiving capability information indicating capabilities of each of the plurality of predetermined image forming apparatuses from a respective one of the plurality of predetermined image forming apparatuses;
storing the received capability information;
receiving a request from the external apparatus;
transmitting capability information indicating a capability that all the plurality of predetermined image forming apparatuses has to the external apparatus based on the received request, the capability information being included in the received capability information.

23. A non-transitory computer-readable storage medium storing a program that, when executed by a computer, causes the computer to perform a method of controlling an external apparatus, the method comprising:
displaying the capability information as a print setting; and
requesting the information processing apparatus capability information indicating a capability that all the plurality of predetermined image forming apparatuses has,
wherein the displaying includes displaying the capability information indicating the capability that all the plurality of predetermined image forming apparatuses has.
